(19) United States
(12) Patent Application Publication
(10) Pub. No.: US 2005/0050004 A1
(43) Pub. Date: Mar. 3, 2005

(54) Methods for generating and distribution of group key in a wireless transport network

(76) Inventors: Ming-Jye Sheu, San Jose, CA (US); Ted Tsei Kuo, Palo Alto, CA (US); Tyan-Shu Jou, Cary, NC (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/947,583

(22) Filed: Sep. 22, 2004

Related U.S. Application Data
(63) Continuation of application No. 10/918,005, filed on Aug. 13, 2004.
(60) Provisional application No. 60/495,185, filed on Aug. 15, 2003.

(51) Int. Cl. G06F 7/00

(52) U.S. Cl. 707/1

(57) ABSTRACT

The present invention provides a method of distributing a new group key by a designated group key server, comprising: receiving a group key by a wireless device from each of a newly discovered neighbor. The next step is to receive a list of devices that the newly discovered neighbor connects to. Then, the device determines whether or not the received group key is the same with a new group key and a key index from a neighbor Ni and to associate each the group key with the list of device received from the same neighbor. The device compares all the group keys from the each neighbor and merging an associated lists of device into a single list if the group keys are the same. Subsequently, the device selects the group key with the largest associated list of device be a new selected group key.

### CROSS-REFERENCE TO RELATED APPLICATIONS

The application is a continuation of a pending application No. 10/918,005, filed on Aug. 13, 2004, entitled “Methods and Apparatus for Distribution of Global Encryption Key in a Wireless Transport Network,” which claimed the benefit of provisional application Ser. No. 60/495,185, filed on Aug. 15, 2003, entitled “Methods and Apparatus for Broadcast Traffic Reduction on a Wireless Transport Network”. The contents of both of the above-referenced applications are incorporated herein by reference.

### FIELD OF THE INVENTION

The present invention relates to wireless communications systems, more particular, to a wireless transport network system that is capable of generating and distributing a group key in a wireless network.

### BACKGROUND OF THE INVENTION

Typical wireless network systems comprise one or more access devices for communication purposes. The users may be communicated with the access device with personal computers or notebook computers via wireless means. Wireless local area networks (WLANs) were originally intended to allow wireless connections to a wired local area network (LAN), such as where premises wiring systems were nonexistent or inadequate to support conventional wired LANs. WLANs are often used to service mobile computing devices, such as laptop computers and personal digital assistants (PDAs). Typically, Access Points (APs) are set to ensure adequate radio coverage throughout the service area of the WLAN, while minimizing the costs associated with the installation of each AP. The APs must be configured to eliminate coverage gaps and to provide adequate coverage.

A wireless transport network is a network comprises a plurality of wirelessly connected devices that are responsible for relaying traffic for associated mobile clients. An example of a wireless transport network is a plurality of IEEE 802.11 capable devices that provide transport service for IEEE 802.11 or Bluetooth capable clients such as laptop computers, PDA (personal digital assistant), and the like. The network can further comprise one or more connections to a wired network through one or multiple edge devices. The edge devices are equipped and capable of both wireless and wired communication.

In a wireless transport network, confidentiality and authenticity of data traffic is most important. The transmission domain (the air) by nature is not secured and therefore encryption is essential in any wireless transport networks. Pair-wise encryption/decryption between every neighboring wireless network device of a wireless transport network is inefficient and time-consuming if hardware-assist encryption and decryption is not available. A data frame that leaves from one wireless device from one end of a wireless transport network to the other end of the same network might need several encryptions and decryptions before it reaches its final destination. Furthermore, a group key for a broadcast or a multicast data frame is still needed in addition to pair-wise encryption keys. A more efficient and easy-to-manage encryption/decryption scheme in a wireless transport network is to use a global encryption key for wireless transport network encryption service. Once a data frame from client mobile station enters a wireless transport network, it is encrypted only once until it reaches the exit wireless device, where it would be decrypted once.

Furthermore, in a wireless transport network, wireless devices might be temporary out of service, resulting in separated network segments. Each of the network segments might have a different global encryption key, which is used in the confine of the segment. When network segments are joined by a new wireless device, a new global encryption key is needed. The invention is particularly concerned with deploying a unique global encryption key for wireless devices that form a wireless transport network and with several wireless transport network segments that are joined by a new wireless device.

### SUMMARY

One purpose for the present invention is to provide an encryption key distribution method in a wireless transport network. A plurality of wireless transport devices and at least one edge device are needed in the network.

On embodiment provides a method of generating and distributing a new group key by a designated group key server after the new group key is generated, comprising setting a value of a group key index to group key index plus 1. Server checks a neighbor table for each entry Ni in a neighbor table. It updates the new group key and the new group index in each the entry Ni if the entry Ni has not been updated, and encrypting the new group key and the group key index using an encryption key of the entry Ni. Then, the server sends the encrypted group key update message to the entry Ni.

Further, the present invention also providing a further method of distributing a new group key by a newly joined wireless transport device, comprising: receiving a group key by a wireless device from each of the newly discovered neighbors. The next step is to receive a list of devices that the newly discovered neighbor connects to. The device compares all the group keys from the each neighbor and merging an associated lists of device into a single list if the group keys are the same. Subsequently, the device selects the group key with the largest associated list of device be a new selected group key.

A method of mutual authentication between a first wireless transport device and a second wireless transport device, comprising: generating a first random number as a first cookie message element by the first wireless transport device; sending a first hello message to the second wireless transport device by the first wireless transport device with a chosen cookie in the first cookie message element; upon receiving the first Hello message, the second wireless transport device generating a second random number as a second cookie message element; sending a second Hello message to the first wireless transport device by the second wireless transport device with a message element; upon receiving the second Hello message, the first wireless transport device verifying a signature of the second wireless transport device by computing the second Hello message using a pre-shared key value of the first wireless transport device; sending a third Hello message by the first wireless transport device with a message elements; receiving by the second wireless transport device the third Hello message and verifying a signature of the first wireless transport device using a configured pre-shared key of the second wireless transport device, if the signature of the first wireless transport device is correct, wherein the second wireless transport device sends a fourth Hello message indicating the mutual authentication is success to the first wireless transport device, otherwise, indicting the mutual authentication has failed.

The method further comprises a step of generating a pair-wise encryption key when both the first and second wireless transport device have successfully authenticated each other. Once the first wireless transport device has mutually authenticated with all discovered neighbors, the first wireless transport device sending a configuration request to each of the authenticated neighbor. The configuration request is encrypted by the pair-wise encryption keys that are generated after each mutual authentication process. The cookie message element serves both in identifying a mutual authentication session with the second wireless transport device and in providing key freshness when generating pair-wise key after the mutual authentication is completed.

The method further comprises a step of optionally generating by the second wireless transport device a Diffie-Hellman public key (DH_PubKey_B); and signing a MAC address of the second wireless transport device using a pseudo random function (PRF) and a pre-configured pre-shared key. Wherein the PRF is HMAC-MD5 or HMAC-SHA1, the HMAC-MD5 is used as a default PRF. The third hello message includes an optional Diffie_Hellman public key of the first wireless transport device (DH_PubKey_A) and the first wireless transport device's own signature HASH_A. If the signature of the second wireless transport device does not match, the method further comprises a step of sending a forth Hello message to the second wireless transport device by the first wireless transport device

### BRIEF DESCRIPTION OF THE DRAWINGS

FIG. 1 illustrates an example of a wireless transport network.

FIG. 2 is a flow chart of the present invention.

FIG. 3 shows the protocol header and message format including Control/Management Frame Format and Data Frame Format of the present invention.

FIG. 4 shows the shim header format having 24 byte of the present invention.

FIG. 5 illustrates an example of the format of a WIT control message of the present invention.

FIG. 6 illustrates WIT message header format of the present invention.

FIG. 7 illustrates message element format of the present invention.

FIG. 8 illustrates the procedure performed by the designated group key server when a new group key is generated

FIGS. 9A and 9B illustrate the flow chart for the key distribution by designated group key server.

FIG. 10 shows the discovery and mutual authentication protocol for the wireless transport devices.

Resolving Multiple Group Keys during Discovery Process

FIG. 11 and FIG. 12 show two different scenarios with respect to group key installation.

FIG. 13 is a flow chart showing the algorithm that converge different group keys from each island into a single group key in a wireless transport network.

### DETAILED DESCRIPTION

The present invention provides a method and a means for providing secured communication in a wireless transport network. The invention provides a method to create, maintain, and distribute global encryption key to all wireless devices in a wireless transport network.

Wireless Transport Network

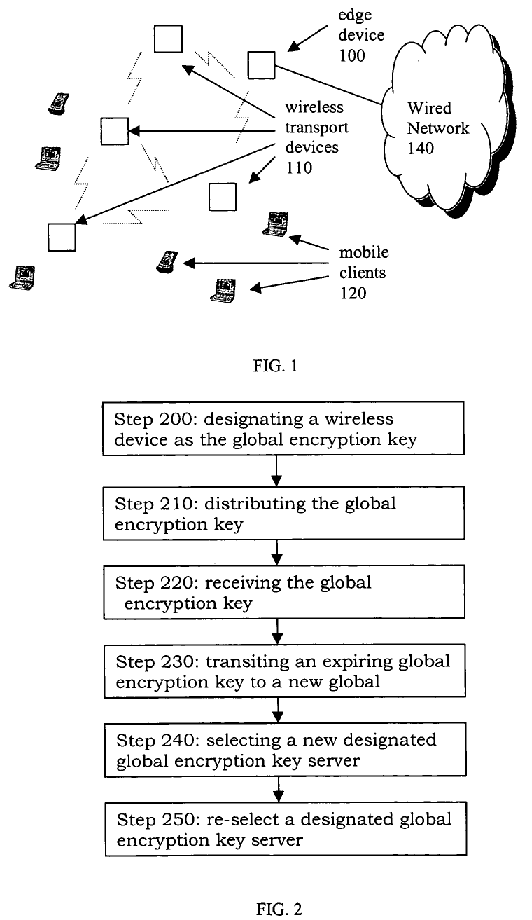

FIG. 1 illustrates a communication network including at least one edge device 100. The wired LANs 140 could be joined by the edge device 100, bridges and access points or base stations (not shown). The present invention further includes a plurality of wireless transport devices 110 coupled to the edge devices 100 by wireless networking. The wireless transport devices 110 are capable of relaying the broadcast frame on the wireless network. The edge devices 100 are also equipped and capable of both wireless and wired communication. This arrangement can not be found in the prior art. Each edge device 100 communicates with a wireless transport device 110, and the wireless transport devices 110 communicate to the other neighbor device, such as one or more mobile terminals (clients) 120 or other neighboring wireless transport devices. Please refer to FIG. 1, a wireless transport network includes a plurality of IEEE 802.11 capable devices that provide transport service for IEEE 802.11 or Bluetooth capable clients such as laptop computers, PDA (personal digital assistant) or the like. The network can further comprise one or more connections to a wired network through one or multiple edge devices.

As illustrated in FIG. 1, all of the wireless transport devices may forward broadcast frame via wireless network to other mobile client or wireless transport device. The present invention is not directed to controlling the path of the transmission but is concerned with encryption and/or decryption service in the wireless network. The wireless transport device includes a table with the information that contains the neighboring device from which a broadcast frame originated from a particular wireless transport device can be received. Therefore, a wireless network includes at least one edge device 100 that coupled between wired LAN 140 and wireless LAN. At least one wireless transport device 110 is coupled to the edge device 100 and the at least one mobile device 120 via the wireless network. The devices may construct a segment of the wireless transport network.

Method of Providing Encryption Service

The novel aspect according to the present invention is a method of providing encryption service in a wireless transport network. Please refer to FIG. 2, the method includes an initial step 200 of designating a wireless device as the global encryption key server that creates and maintain global encryption key for wireless transport network encryption. The wireless device could be any portable wireless device, the wireless transport device or the edge device. The devices mentioned above thereby constructing a segment of the wireless transport network. Subsequently, please refer to step 210, the global encryption key is distributed from the global encryption key generator (the designated wireless device) to all other wireless devices in the same wireless transport network. After the device received the global encryption key, in step 220, the device will perform a subsequent process to replace an existing global encryption key with a new key, namely the current received global encryption key. Next, the device transits an expiring global encryption key to a new global encryption key in the same wireless transport network without traffic loss and security shown in step 230 of the FIG. 2.

The further step in accordance with the above method includes the step (240) of selecting a new designated global encryption key server by the user, controller or network service provider in the case of temporary failure of the designated global encryption key server in a wireless transport network, please refer to FIG. 2. Then, the system service provider may, step 250, re-select a designated global encryption key server when the failed designated global encryption key server recovered.

Protocol Header and Message Format

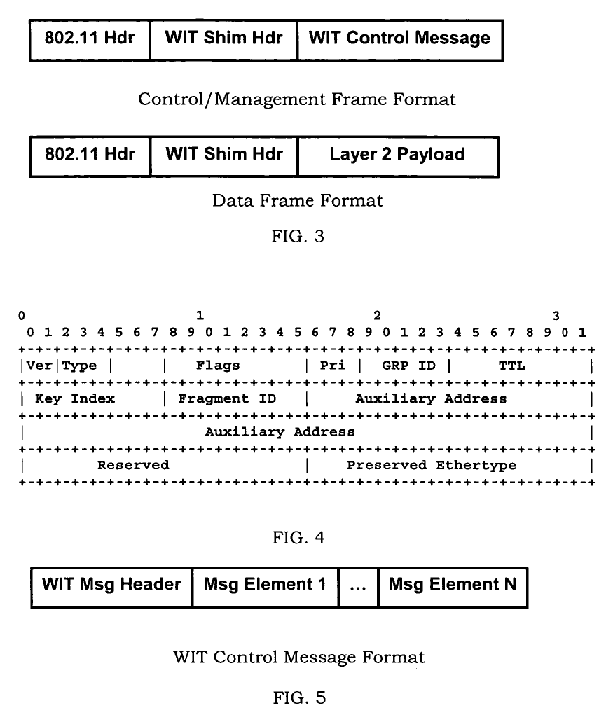

Please refer to FIG. 3, all wireless transport devices in a wireless transport network communicate each other in a regular 802.11 WDS frame format with a special header (WIT Shim Header) that facilitates the control, management, and data transportation of a transport network. FIG. 3 shows the protocol header and message format including Control/Management Frame Format and Data Frame Format. The shim header has 24 byte and the format is shown in FIG. 4. The Key Index field is used indicating which group key is used in a wireless transport network. WIT control messages are used between wireless transport devices in maintaining and managing a wireless transport network, the format of WIT control messages is shown in FIG. 5. For example, during group key distribution process, group key update messages are sent from a wireless transport device to its neighbors.

Thus, the present invention provides architecture of the shim header including:
a group of bits providing Version information including version number;
a group of bits providing Type information;
a group of bits providing Flags information;
a group of bits providing Pri (Priority of the frame) information;
a group of bits providing GRP ID (Group ID) information;
a group of bits providing TTL (Time to live value) information;
a group of bits providing Key Index information;
a group of bits providing Fragment ID information;
a group of bits providing Auxiliary Address information;
a group of bits providing Reserved information; and
a group of bits providing Preserved Ethertype information.

Wherein the group of bits providing Type information includes:
100b control frames for routing messages, neighbor discovery, ping/trace route frames;
010b management frame for client membership announcement; and
000b data frame for from/to clients including client data, configuration, and network management.

The group of bits providing Flags information includes:
Bit 8: membership announcement;
Bit 9: tunnel frame;
Bit 10: backbone node alert;
Bit 11: no forward bit;
Bit 12: fragment flag;
Bit 13: more fragment flag; and
Bit 14-Bit 15: Reserved.

The group of bits providing priority of the frame information includes frame from 0 (lowest) to 7 (highest).

The group of bits providing Key Index information including Group key index, wherein the Group key index is 0 if pair wise key is used between transport devices, if all 0's, the frame is not encrypted.

The group of bits providing Auxiliary Address information includes:
Flag Bit 8 set: Address of originator;
Flag Bit 9 set: Address of tunneled destination transport device; and
Flag Bit 8 and Bit 9 are UNSET and it is broadcast frame: Address of device that sends the broadcast frame two hops before.

The group of bits providing Reserved information includes 2-byte field used to make the header 4-byte aligned. p The group of bits providing Preserved Ethertype information carries an original Ethertype value of the frame.

Please refer to FIG. 5, a WIT control message consists of a message header and 0 or more message elements. The format of a WIT control message is as follows. The format of a WIT control message includes a plurality of message elements from 1-N, N is an integral number.

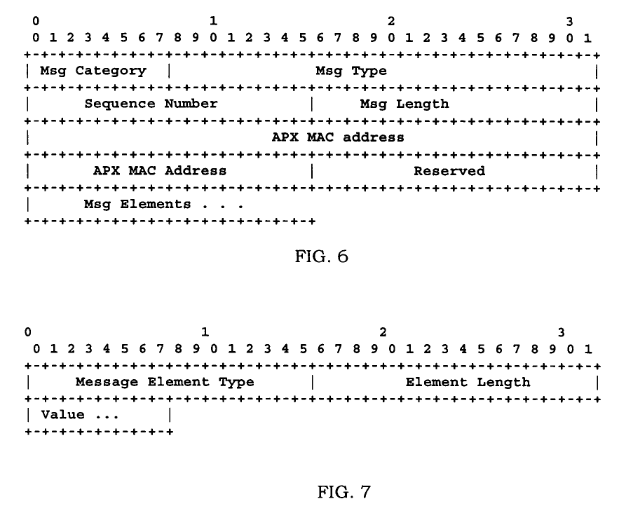

The WIT message header format is shown in FIG. 6. WIT message header includes:
a group of bits providing Message Category information;
a group of bits providing Message Type information;
a group of bits providing Sequence Number information;
a group of bits providing Message Length information;
a group of bits providing APX MAC address information;
a group of bits providing Reserved information; and
a group of bits providing Message Elements information.

FIG. 7 illustrates message element format of the present invention. It includes a group of bits providing Message Element Type information; a group of bits providing Message Length information; and the Value.

Group Key Generation in Wireless Transport Network

Group key is generated by the designated group key server, which is the primary edge wireless device in a wireless transport network. The generation of group key is done by the following method:

Group_Key = PRF (pre-shared key, “mesh-network-group-
key” || Nonce || designated key server's MAC address)

PRF, pseudo random function, used here is HMAC-MD5. Pre-shared key is a pre-configured secret shared by all wireless transport devices in the same wireless transport network. Nonce is a randomly generated 64-bit number that provides freshness of a group key. Using above parameters as the input value, the group key is computed by first concatenating “mesh-network-group-key”, the Nonce, and the MAC address into a single string, and subsequently mixing it with pre-shared key value using HMAC-MD5 as the pseudo random function.
Group Key Distribution in a Wireless Transport Network

After a group key is generated, the designated group key server distributes the new group key through out the wireless transport network. The distribution process can be described in two algorithms. The first is the procedure performed by the designated group key server when a new group key is generated. The second algorithm is the procedure performed by a mesh node when it receives a group key update message from its neighbor.

Key distribution by designated group key server

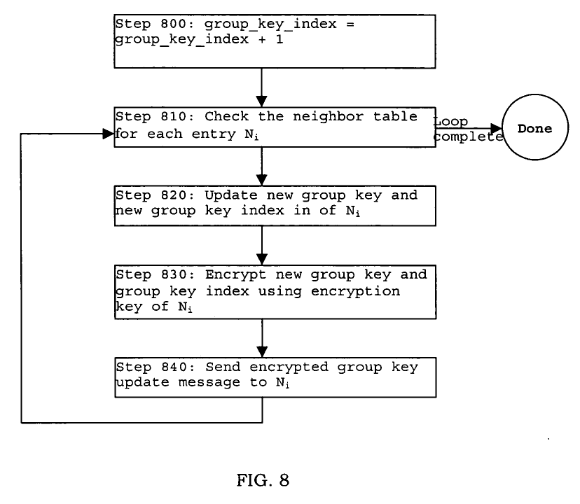

Please refer to FIG. 8, the figure illustrates the procedure performed by the designated group key server when a new group key is generated. The group key server will alter the group key at a certain cycle or random. Thus, in order to generate the new group key, in step 800, the group key server sets the value of the group key index to current group key index plus 1. Next, the server checks the neighbor table for each entry Ni in neighbor table in step 810. Then, the server updates a new group key and a new group index in each entry Nᵢ if the one has not been updated (820). The next step is to encrypt the new group key and group key index using encryption key of Nᵢ in step 830, thereafter, sending the encrypted group key update message to entry Nᵢ (840). Then, the group key server will return to the step of 810 until all of the loops are complete.

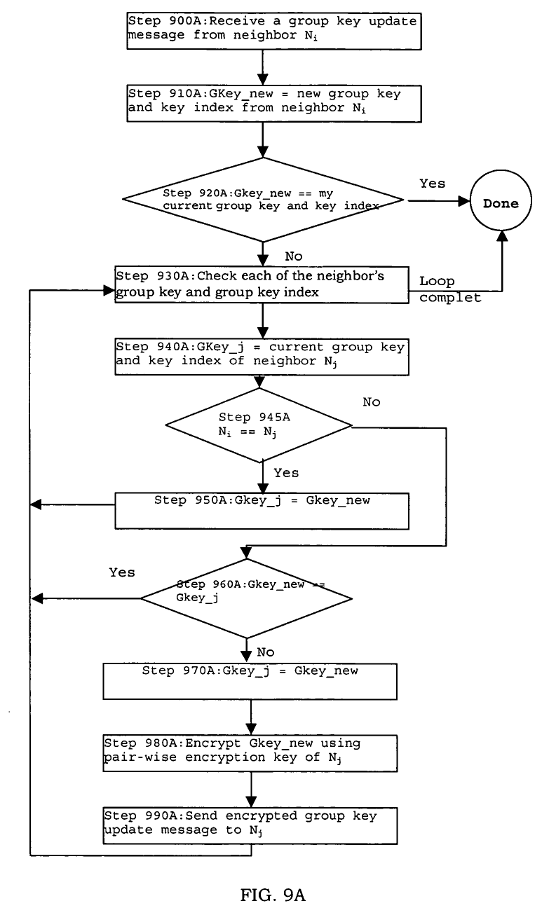

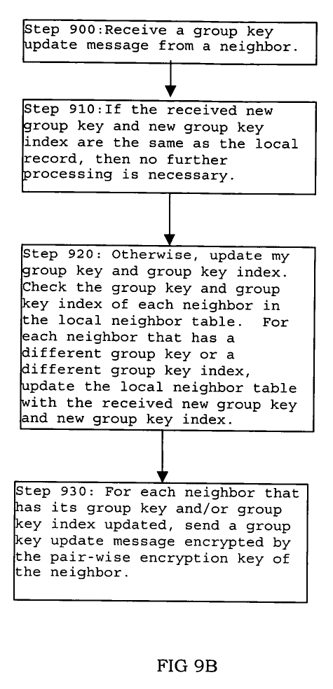

Key distribution by a wireless transport device is shown in FIG. 9A and 9B. In step 900 of FIG. 9B, a wireless transport device receives a group key update message from a neighbor. In step 910, the received new group key and key index are compared with the group key and group key index currently used. If they are the same, no further processing is needed. Otherwise, in step 920, update the local group key and group key index with the new ones received. Check each of the neighbor's group key and group key index in the neighbor table. Update the information in the neighbor table for those neighbors that do not have the same group key value and group key index. Finally in step 930, send a group key update message encrypted by a pair-wise encryption key for each of the neighbor that has its record updated in step 920.

The detailed flow of the above method is described as following accompanying with the FIG. 9A.
900A: receiving a group key update message from neighbor Nᵢ;
910A: setting GKey_new to be the new group key and new key index received.
920A: determining whether or not the current group key and key index are the same with the received group key and key index, if they are the same, no further processing is needed.
930A: otherwise, checking each of the neighbor's group key and group key index in the neighbor table. The following steps are to update the information in the neighbor table for those neighbors that do not have the same group key value and group key index.
940A: setting GKey_j to be the current group key and key index of neighbor Nⱼ
945A: The step is to determine whether or not the current entry Nⱼ is the sender of the new group key.
950A: if current entry Nⱼ is the sender of the new group key, then update the entry with GKey_new and go to step 930A.
960A: otherwise, checking whether new GKey_new is the same with the GKey_j. If yes, then go to step 930A.
970A: Otherwise, updating Nⱼ table entry with the GKey_new.
980A: Encrypting new group key using pair-wise encryption key of Nⱼ.
990A: Sending encrypted group key update message to Nⱼ and goes to step 930A.
   Mutual Authentication Protocol between Wireless Transport Devices before Sending Group Key

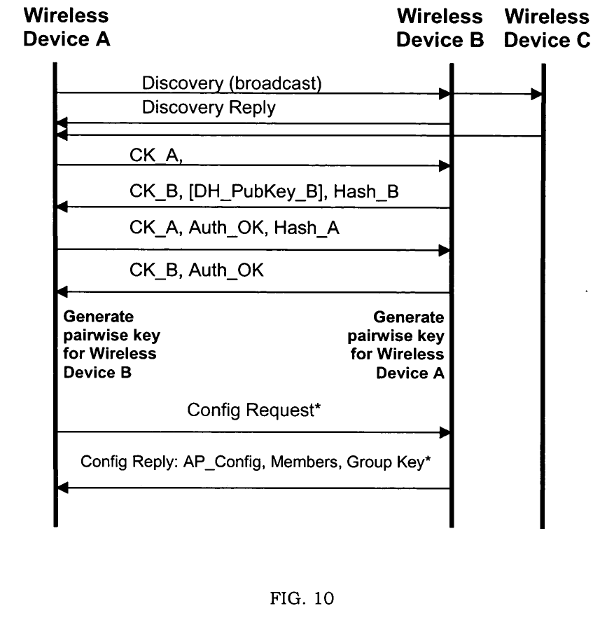

A wireless transport device automatically discovers its neighboring devices and performs mutual authentication. The following diagram in FIG. 10 shows the discovery and mutual authentication protocol for the wireless transport devices. For example, the wireless device A decides to join to a wireless transport network. To discover any neighboring wireless transport devices, it first broadcasts a Discovery message. Any wireless transport device that receives the Discovery message sends a Discovery Reply message to device A. After a short interval, device A then starts mutual authentication process to each of devices from which the Discovery Reply message is received.

The following steps describe mutual authentication process between device A and device B.
1. Device A generates a random number (CK_A) as the cookie message element. This random number is 32-bit for example. This cookie payload serves both in identifying a mutual authentication session with device B and in providing key freshness when generating pair-wise key after mutual authentication is completed.
2. Device A sends the first Hello message to device B with the chosen cookie in cookie message element.

3. Upon receiving the first Hello message, device B generates a random number CK_B as its cookie for example. Optionally, the wireless device B can generate its Diffie-Hellman public key (DH_PubKey_B). B then signs its MAC address using the pseudo random function (PRF) and the pre-configured pre-shared key. A typical PRF could be HMAC-MD5 or HMAC-SHA1. We use HMAC-MD5 as the default PRF. The signature HASH_B is then computed as:

HASH_B = PRF (pre-shared key, “mesh-network” || B's MAC
address)
or if a DH_PubKey_B is used:
HASH_B =PRF (pre-shared key, “mesh-network” ||
DH_PubKey_B || B's MAC address)

4. Device B sends the second Hello message to device A with message elements CK_B, optional DH_PubKey_B, and then HASH_B
5. Upon receiving the second Hello message, device A verifies device B's signature by computing the HASH_B using device A's pre-shared key value. If the signature does not match, device A sends the third Hello message with message elements CK_A and AUTH_FAILED to device B.

If the signature is verified, device A sends the third hello message with message elements CK_A, optionally Diffie_Hellman public key (DH_PubKey_A), AUTH_OK, and its own signature HASH_A. HASH_A is computed as:

```
    HASH_A = PRF (pre-shared key, “mesh-network” || A's MAC
        address)
or if a DH_PubKey_A is used:
    HASH_B  = PRF  (pre-shared  key,  “mesh-network” ||
    DH_PubKey_A
        || A's MAC address)
```

If Diffie-Hellman is used, then a Diffie-Hellman (DH_Shared_Secret) shared secret can be computed at this time.
6. Finally, device B receives the third Hello message and verifies the signature of device A using its own configured pre-shared key. If the signature does not match HASH_A, B sends the fourth and the last Hello message with message elements CK_B and AUTH_FAILED to indicate mutual authentication has failed. If A's signature is correct, device B sends the fourth and the last Hello message with message elements CK_B and AUTH_OK to device A. If Diffie-Hellman is used, then a Diffie-Hellman (DH_Shared_Secret) shared secret can be computed at this time.

7. When both device A and device B have successfully authenticated each other, a pair-wise encryption key is generated using the following method

```
Let min_cookie = min (CK_A, CK_B)
    max_cookie = max (CK_A, CK_B)
    min_mac = min (A's MAC address, B's MAC address)
    max_mac = max (A's MAC_address, B's MAC address)
PairwiseKey = PRF (pre-shared key, “JS Pairwise Key” ||
        min_cookie || max_cookie || min_mac ||
        max_mac)
or if Diffie-Hellman is used
  PairwiseKey = PRF (pre-shared key, “JS Pairwise Key” ||
        min_cookie || max_cookie || min_mac ||
        max_mac || DH_Shared_Secret);
```

Once device A has mutually authenticated with all the discovered neighbors, it sends configuration request to each of the authenticated neighbor. Config Request messages are encrypted by the pair-wise encryption keys that are generated after each mutual authentication process. Among the message elements in the Config Reply is the group key used by the current mesh network.

Resolving Multiple Group Keys during Discovery Process

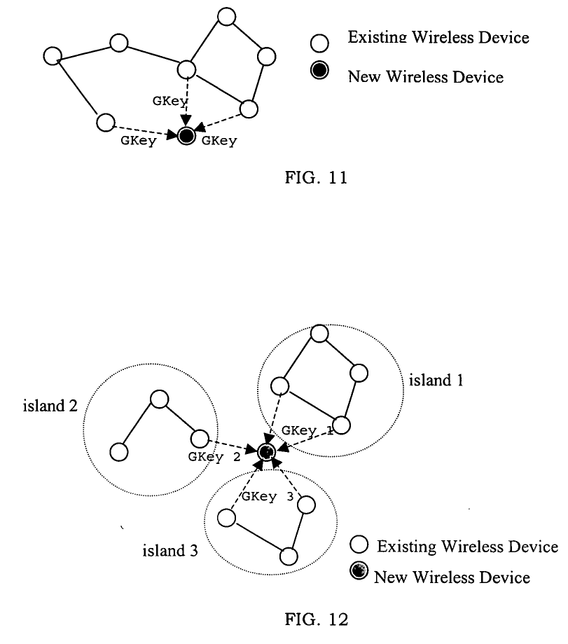

When a wireless transport device that joins a wireless transport network, there are two different scenarios with respect to group key installation. Please refer to FIG. 11 (case 1) and FIG. 12 (case 2).

Case 1:

In this case, the new wireless device receives the same group key from all of its new neighbors. This is because new neighbors are in the same wireless transport network.

Case 2:

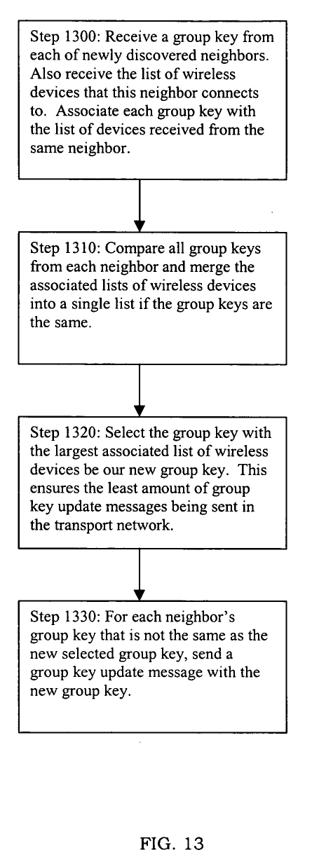

In this case, the new wireless device receives different group keys from its neighbors. This is because the wireless transport network is divided into one or more islands. The following flow chart in FIG. 13 shows the algorithm that converge different group keys from each island into a single group key in a wireless transport network. This algorithm also guarantees that a group key that serves the most wireless transport devices will be chosen as the new group key. The result is an algorithm with the least group key update messages needed in a wireless transport network. The wireless device receives a group key from each of newly discovered neighbors such as Nᵢ (step 1300). Also receive the list of wireless devices that this neighbor connects to. The device will determine the received group key is the same with the new group key and key index from the neighbor Nᵢ in step 1310. Associate each group key with the list of devices received from the same neighbor. In step 1310, the device compares all group keys from each neighbor and merges the associated lists of wireless devices into a single list if the group keys are the same. Next, in step 1320, the device selects the group key with the largest associated list of wireless devices be the new group key. This step ensures the least amount of group key update messages being sent in the transport network. Next in step 1330, the wireless device sends a group key update message with the new group key for each neighbor's group key that is not the same as the new selected group key.

When a wireless transport device receives different group keys and group key indices from its newly discovered neighbor, it has to choose a new group key and key index and updates the rest of the wireless transport devices in the network. To reduce the number of group key update messages sent in the wireless network, the group key and group key index that are used by the most wireless transport devices should be selected. This can be achieved by keep tracking the group key and its associated wireless transport devices. The group key and group key index with the largest associated wireless transport devices will be used as the new group key and group key index for the wireless network.

Therefore, the present invention provides the unique method for generating and distributing the group key for wireless transport devices that form a part of the wireless transport network.

It will be appreciated that the preferred embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A method of generating a new group key by a designated group key server after said new group key is generated, comprising:
setting a value of a group key index to group key index plus 1;
checking a neighbor table for each entry Nᵢ in a neighbor table;
updating said new group key and said new group index in each said entry Nᵢ if said entry Nᵢ has not been updated;
encrypting said new group key and said group key index using an encryption key of said entry Nᵢ; and
sending a update message of said encrypted group key to said entry Nᵢ.

2. A method of generating a new group key by a designated group key server, comprising:
receiving a group key by a wireless device from each of a newly discovered neighbors;
receiving a list of devices that said newly discovered neighbor connects to;
determining whether or not said received group key is the same with a new group key and a key index from a neighbor Ni;
associating each said group key with said list of device received from the same neighbor;
comparing all said group keys from said each neighbor and merging an associated lists of device into a single list if said group keys are the same; and
selecting said group key with the largest associated list of device be a new selected group key.

3. The method of claim 2, further comprising a step of ensuring the least amount of group key update messages being sent in a transport network.

4. The method of claim 2, further comprising a step for a wireless device to send a group key update message with said new group key for said each neighbor's group key that is not the same as said new selected group key.

5. A method for a wireless transport device automatically discovers a neighboring device and performs a mutual authentication, comprising:
deciding to join to a wireless transport network by a wireless transport device;
discovering any neighboring wireless transport devices;
broadcasting a discovery message;
sends a discovery reply message to said wireless transport device by said any neighboring wireless transport device that receives said discovery message; and
starting a mutual authentication process by said wireless transport device to each of said any neighboring wireless transport device that receives said discovery message.

6. A method of mutual authentication between a first wireless transport device and a second wireless transport device, comprising:
generating a first random number as a first cookie message element by said first wireless transport device;
sending a first hello message to said second wireless transport device by said first wireless transport device with a chosen cookie in said first cookie message element;
upon receiving said first Hello message, said second wireless transport device generating a second random number as a second cookie message element;
sending a second Hello message to said first wireless transport device by said second wireless transport device with a message element;
upon receiving said second Hello message, said first wireless transport device verifying a signature of said second wireless transport device by computing said second Hello message using a pre-shared key value of said first wireless transport device;
sending a third Hello message by said first wireless transport device with a message elements;
receives by said second wireless transport device said third Hello message and verifying a signature of said first wireless transport device using a configured pre-shared key of said second wireless transport device, if said signature of said first wireless transport device is correct, wherein said second wireless transport device sends a fourth Hello message indicating said mutual authentication is success to said first wireless transport device, otherwise, indicting said mutual authentication is failed;

7. The method of claim 6, further comprising a step of generating a pair-wise encryption key when both said first and second wireless transport device have successfully authenticated each other.

8. The method of claim 7, wherein once said first wireless transport device has mutually authenticated with all discovered neighbors, said first wireless transport device sending a configuration request to each of said authenticated neighbor.

9. The method of claim 8, wherein said configuration request is encrypted by said pair-wise encryption keys that are generated after each mutual authentication process.

10. The method of claim 6, wherein said cookie message element serves both in identifying a mutual authentication session with said second wireless transport device and in providing key freshness when generating pair-wise key after said mutual authentication is completed.

11. The method of claim 10, further comprising a step of generating by said second wireless transport device a Diffie-Hellman public key (DH_PubKey_B); and
signing a MAC address of said second wireless transport device using a pseudo random function (PRF) and a pre-configured pre-shared key.

12. The method of claim 11, wherein said PRF is HMAC-MD5 or HMAC-SHA1.

13. The method of claim 12, wherein said HMAC-MD5 is used as a default PRF.

14. The method of claim 6, wherein said third hello message with said message element including a Diffie_Hellman public key of said first wireless transport device (DH_PubKey_A) and said first wireless transport device's own signature HASH_A.

15. The method of claim 6, further comprising a step of sending a forth Hello message to said second wireless transport device by said first wireless transport device if said signature of said second wireless transport device does not match.

16. A method of generating a Group Key in a Wireless Transport Network, comprising:
computing said group key using parameters as an input value by a first concatenating “mesh-network-group-key”, a Nonce, and a MAC address into a single string;
mixing said group key with a pre-shared key value using a pseudo random function.

17. The method of claim 16, wherein said pseudo random function is HMAC-MD5.

18. The method of claim 16, wherein said pre-shared key is a pre-configured secret shared by all wireless transport devices in said wireless transport network.

19. The method of claim 16, wherein said Nonce is a randomly generated 64-bit number that provides freshness of a group key.

20. The method of claim 16, wherein said group key is generated by a designated group key server.

21. The method of claim 20, wherein said designated group key server is the primary edge wireless device in said wireless transport network.

22. A method of converging different group keys from each island into a single group key in a wireless transport network, comprising:
receiving a group key by a wireless device from a newly discovered neighbor and also receiving a list of wireless devices that said newly discovered neighbor connects to;
determining whether said received group key is the same with a new group key and key index from said newly discovered neighbor;
associating each group key with said list of devices received from said newly discovered neighbor;
comparing all group keys from each neighbor and merging said associated lists of wireless devices into a single list if said group keys are the same;
selecting said group key with the largest associated list of wireless devices be the new group key.

23. The method of claim 22, further comprises a step to ensure a group key update messages being sent in said transport network.

24. The method of claim 22, further comprises a step of sending a group key update message with said new group key for said each neighbor's group key that is not the same as the new selected group key.
